(19) United States
(12) Patent Application Publication
(10) Pub. No.: US 2025/0304833 A1
(43) Pub. Date: Oct. 2, 2025

(54) WASH OFF PRESSURE SENSITIVE ADHESIVE FOR PET

(71) Applicants: Dow Global Technologies LLC, Midland, MI (US); Rohm and Haas Company, Collegeville, PA (US)

(72) Inventors: Asghar A. Peera, Royersford, PA (US); Isabelle Uhl, Grasse (FR); Pavel Janko, Tarragona (ES); Michael A. Mallozzi, Hatfield, PA (US); Saswati Pujari, Collegeville, PA (US); David Dispasquale, Collegeville, PA (US); Li Li, Collegeville, PA (US)

(21) Appl. No.: 18/862,243

(22) PCT Filed: May 16, 2023
(86) PCT No.: PCT/US2023/022424

§ 371 Date: Nov. 1, 2024

Related U.S. Application Data
(60) Provisional application No. 63/365,041, filed on May 20, 2022.

(51) Int. Cl. C09J 7/38; B08B 3/04; B08B 3/08; C09J 5/00; C09J 11/04; C09J 11/06; G09F 3/02; G09F 3/10

(52) U.S. Cl. CPC C09J 7/385; B08B 3/044; B08B 3/08; C09J 5/00; C09J 11/04; C09J 11/06; G09F 3/02; G09F 3/10; C09J 2203/334; C09J 2301/302; C09J 2301/408; C09J 2301/414; C09J 2301/502; G09F 2003/0241; G09F 2003/0244

(57) ABSTRACT

A pressure sensitive adhesive (PSA) that can be washed of substrates is disclosed. The PSA can be comprised of at least one hydrophilic monomer, at least one hydrophobic monomer, at least one neutralizer and at least one surfactant. A label with an acrylic binder coasted substrate layer and a PSA layer wherein the PSA layer is comprised of at least one hydrophilic monomer, at least one hydrophobic monomer, at least one neutralizer, and at least one surfactant.

### FIELD

The current disclosure relates to a pressure sensitive adhesive (PSA) that washes off various substrates. More specifically, the current disclosure relates to a pressure sensitive adhesive layer comprised of at least one hydrophilic monomer, at least one hydrophobic monomer, at least one neutralizer, and at least one surfactant.

### BACKGROUND

Adhesive compositions are useful for a wide variety of purposes. One particularly useful subset of adhesive compositions is water-based pressure sensitive adhesives. The use of water-based pressure sensitive adhesives in different end-use applications is generally known. For instance, water-based pressure sensitive adhesives can be used with labels, notepads, tapes, decals, bandages, decorative and protective sheets, and a wide variety of other products.

As used in the art, the term “pressure sensitive adhesive” designates a material comprising one or more polymer compositions which, when dried, is aggressively and permanently tacky at various temperatures. Further, the term “water-based” indicates that the pressure sensitive adhesive is manufactured with an aqueous carrier. A typical water-based pressure sensitive adhesive will firmly adhere to a variety of dissimilar surfaces upon mere contact without the need of more than finger or hand-applied pressure.

Pressure sensitive adhesives are often used to attach paper or film labels to PET. PET is generally recyclable, but often only if the PSA can be easily removed. Crushing PET containers with PSA labels still attached causes processing challenges and contamination. Currently temperatures of 80° C. or higher are necessary to remove labels from substrates. Labels and adhesive that can be cleanly removed from the substrate such as PET without excessive heat would allow reuse of containers with minimal post processing. Therefore, a PSA based label that can be easily washed off at low temperatures is desirable.

### DETAILED DESCRIPTION

The current disclosure relates to a pressure sensitive adhesive (PSA) that can be washed off substrates. More specifically, a PSA layer comprised of at least one hydrophilic monomer, at least one hydrophobic monomer, at least one neutralizer, and at least one surfactant. Currently disclosed, is a label with a hydrophilic or hydrophobic acrylic binder coated substrate layer and a PSA layer wherein the PSA layer is comprised of at least one hydrophilic monomer, at least one hydrophobic monomer, at least one neutralizer, and at least one surfactant. Optionally, treated with an acrylic binder with Tg greater than 5° C.

The PSA can be removed, according to the current disclosure, using a constantly agitated bath at a temperature less than 85 degrees Celsius and at a pH between 7 and 14.

### Substrate Layer

The presently disclosed substrate layer used to form the wash-off label may comprise a single layer of substrate material or may be formed of a multi-layer construction. The properties of the materials used to form the substrate layer and the intended use and desired performance properties of the label may determine the selection of the appropriate materials and construction for use as the substrate layer. In the case of multi-layer substrates, the important consideration is the nature of the outer layer which is in contact with the PSA layer.

In multi-layer substrates, it may be advantageous for one or more of the layers that are not the layer in contact with the PSA to be stressed substrates such as monoaxially or biaxially stretched polyvinyl chloride or other stretchable substrates which will curl and aid in pulling the label away from the glass or plastic substrate when subjected to suitable wash-off conditions.

A wide variety of materials may be used to form the substrate layer, including paper and polymeric compositions. The material may be primed or unprimed. The material can be shrinkable/expandable or non-shrinkable. It may be surface treated by, for example, corona discharge, flame, plasma, etc., to provide the surfaces with desirable properties such as improved adhesion to subsequently applied layers. Procedures for corona treating and flame treating of polymeric substrates are well known to those skilled in the art.

The substrate layer may be a monolayer substrate or a multilayer substrate. The multilayer substrate may comprise of two or more layers. The substrate layer may be oriented or not oriented. It may be transparent or opaque.

Polymers suitable for use in preparing the substrate layer(s), may include, for example, polymers and copolymers of one or more of the following: polyolefin, polyacrylate, polystyrene, polyamide, polyvinyl alcohol, poly(alkylene acrylate), poly(ethylene vinyl alcohol), poly(alkylene vinyl acetate), polyurethane, polyacrylonitrile, polyester, polyester copolymer, fluoropolymer, polysulfone, polycarbonate, styrene-maleic anhydride copolymer, styrene-acrylonitrile copolymer, ionomers based on sodium or zinc salts of ethylene methacrylic acid, polyacrylonitrile, alkylene-vinyl acetate copolymer, or so-called “biopolymers”, or mixtures of two or more of the foregoing. The substrate layer may comprise polyamide film, such as polyamide 6, polyamide 11 and polyamide 12.

As presently disclosed, the plastic substrate of the substrate layer can be either unstressed (i.e., not stretched), or stretched in at least one direction. In a multilayer substrate, only one, or less than all, of the layers may be monoaxially or biaxially stretched. In the case of multilayer substrates in which more than one layer is stretched, the layers may all be stretched in essentially the same orientation, or different layers may be stretched in different orientations relative to each other.

As presently disclosed, the substrate layer, or at least the layer of a multilayer substrate bearing the adhesive layer may be treated before application of the adhesive layer, for example by corona treatment, flame pretreatment, plasma pretreatment or chemical grafting, or with the aid of an adhesion-promoting intermediate layer containing, for example, chlorinated polyolefins, chlorinated rubber, ethylene/vinyl acetate (EVA) copolymer, chlorinated polypropylene or polymerized ethylene/acrylamide comonomers. The substrate may also be treated by acrylic binder with Tg greater than 5° C. which can be obtained from DOW chemical. The acrylic binder can be applied to the substrate at a rate of 0.05-3.0 gsm. The acrylic binder can be applied to the PET at a rate of 0.05-3.0 gsm.

### PSA Layer

Presently disclosed is a PSA layer formed by drying an aqueous polymer dispersion. The polymer of that dispersion comprises at least one hydrophilic monomer, and at least one hydrophobic monomer. The PSA also comprises at least one neutralizer and at least one surfactant. The PSA can have between 50%-90% hydrophobic monomer, between 50%-80% hydrophobic monomer, between 50%-70% hydrophobic monomer, or between 50%-60% hydrophobic monomer. Examples of acceptable hydrophobic monomers include, but are not limited to, alkyl acrylates such as butyl acrylate, ethylhexyl acrylate, octyl acrylate, isooctyl methacrylate, decyl methacrylate, isodecyl methacrylate, lauryl methacrylate, pentadecyl methacrylate, stearyl methacrylate, and C12 to C18 alkyl methacrylates. All weight percents are based on the total weight of the adhesive composition.

The PSA can have between 25-30% hydrophilic monomers, between 26-30% hydrophilic monomers, between 27-30% hydrophilic monomers, between 28-30% hydrophilic monomers or between 29-30% hydrophilic monomers. Examples of acceptable hydrophilic monomers include, but are not limited to alkyl acrylates such as ethyl acrylate, methyl acrylate, and propyl acrylate, along with acrylic acid, methacrylic acid, hydroxyethyl acrylate, hydroxyethylmethacrylate, hydroxypropyl acrylate and hydroxypropyl methacrylate.

The preparation of aqueous dispersions of water-insoluble latex polymers by emulsion polymerization is well known in the art. The practice of emulsion polymerization is discussed in detail in D. C. Blackley, Emulsion Polymerization (Wiley, 1975), and in H. Warson, The Applications of Synthetic Resin Emulsions, Chapter 2 (Ernest Benn Ltd., London 1972). Polymerization methods and useful polymerization aids, such as dispersing agents, initiators, chain transfer agents, and the like are well known, and are described, for example, in published U.S. patent application US2008/0176996.

An initiator can be introduced into a kettle of water in which an emulsified monomer mixture is fed. The initiator can be configured to react with the at least one monomer, thereby forming an emulsion polymer comprising monomer subunits. The initiator can react with the monomer dispersed throughout the aqueous medium until all or substantially all the monomer is polymerized. The end result can be a dispersion of polymer particles in the aqueous medium, the polymer particles comprising the monomer subunits. This dispersion is commonly referred to as an emulsion polymer. Additional oxidation-reduction initiator can be introduced to the emulsion polymer after all of the monomer is fed to the emulsified polymer, in order to reduce monomer residue level.

Reduction-oxidation (redox) initiator systems consisting of at least one, usually inorganic, reducing agent and of an inorganic or organic oxidizing agent are particularly suitable. The oxidation component can comprise, for example, ammonium salts and alkali metal salts of peroxodisulfuric acid, e.g. sodium peroxodisulfate, hydrogen peroxide or organic peroxides, e.g. tert-butyl hydroperoxide, or t-amyl hydroperoxide. The reduction component can comprise, for example, alkali metal salts of sulfurous acid, such as sodium sulfite, sodium hydrogen sulfite, alkali metal salts of disulfurous acid, such as sodium disulfite, bisulfite addition compounds with aliphatic aldehydes and ketones, such as acetone bisulfite, or reducing agents such as hydroxymethanesulfinic acid and its salts, Bruggolite® FF6 or isoascorbic acid. The redox initiator systems can be used along with soluble metal compounds with metallic components able to exist in a plurality of valency states.

Examples of common redox initiator systems are tert-butyl hydroperoxide/sodium bisulfite, tert-butyl hydroperoxide/isoascorbic acid, and tert-butyl hydroperoxide/sodium hydroxymethanesulfinate. The individual components, for example the reduction component, may also be mixtures, for example a mixture of the sodium salt of hydroxymethanesulfinic acid with sodium disulfite.

After polymerization the emulsion polymer dispersed throughout the aqueous medium, can be stabilized by a sodium salt of a fatty alcohol ether sulfate surfactant post additive. The sodium salt of a fatty alcohol ether sulfate surfactant can comprise at least 0.5% of the composition. The sodium salt of a fatty alcohol ether sulfate surfactant can comprise 0.5% to 3% of the composition. The sodium salt of a fatty alcohol ether sulfate surfactant can comprise 1.0% to 1.3% of the composition. The sodium salt of a fatty alcohol ether sulfate surfactant can comprise 1.0% to 3% of the composition. Examples of suitable sodium salts of fatty alcohol ether sulfate surfactants include but are not limited to Disponil® FES 77, FES 32, FES 993, and FES 61 all of which are available from BASF. Other coating additives may also optionally be added.

Sodium Dioctyl Sulfosuccinate (Aerosol® OT-75) and acetylenic diol ethylene oxide/propylene oxide adduct surfactants may also be added to the composition. Sodium dioctyl sulfosuccinate may comprise 0.1% to 3.0% of the composition. Sodium dioctyl sulfosuccinate may comprise 0.2% to 0.5% of the composition. Sodium dioctyl sulfosuccinate may comprise 0.2% to 1.5% of the composition. An acetylenic diol ethylene oxide/propylene oxide adduct surfactant may comprise 0.05% to 1.5% of the composition. An acetylenic diol ethylene oxide/propylene oxide adduct surfactant may comprise 0.1% to 0.5% of the composition. Acceptable acetylenic diol ethylene oxide/propylene oxide adduct surfactants include, but are not limited to, SURFYNOL® 440, SURFYNOL® 104, SURFYNOL® 420, SURFYNOL®450, SURFYNOL® 465, and SURFYNOL® 485. Aerosol ROT-75 is available from Solvay while the SURFYNOL® surfactants are available from Evonik. The acetylenic diol ethylene oxide/propylene oxide adduct surfactant can be replaced or combined with a non-ionic branched secondary alcohol ethoxylate surfactant.

Optionally, water soluble additive(s) to improve wash off performance can be used in combination with the polymer backbone. Examples of water soluble additives are synthetic water soluble polymers such as polyethylene glycol (PEG), polyvinylpyrrolidone (PVP), Poly(vinyl alcohol) (PVOH), Polyacrylic acid (PAA), Polyacrylamides, N-(2-Hydroxypropyl) methacrylamide (HPMA), Divinyl Ether-Maleic Anhydride (DIVEMA), Polyoxazoline, Polyphosphates, Polyphosphazenes, natural water soluble polymers such as Xanthan Gum, Pectins, Chitosan Derivatives, Dextran, Carrageenan, Guar Gum, Cellulose Ethers, Hyaluronic acid (HA), Albumin, Starch or Starch Based Derivatives, or a combination thereof. During washing off of the labels in the wash station, the water solubility and hydrophilicity of polymers such as polyethylene glycol (PEG) and poly vinyl pyrrolidone (PVP) allows the adhesives to come relatively quickly into full-surface contact with the washing liquid, facilities washing liquid penetrating behind the label, and effect the washing-off of the label in the predetermined washing time of the order of some minutes. Examples of water soluble additives include PEG 400, PEG 600, PEG1000, PEG1450, PEG3350, PEG8000, PVP K60, PVP K90 with different molecular weights. Concentration and molecular weight of the water soluble additives need to in balance wash-off performance, adhesion (PSA) properties, viscosity, clarity of dry adhesives, stability of emulsion, % solid, rheology and coatability of the final product formulations. For example, the concentration of the active water soluble additives can range from 0.05% to 20%. Preferably from 0.25-10%.

The currently disclosed PSA contains no effective amount of any crosslinking components, no effective amount of any tackifiers or other additives. The currently disclosed PSA contains no effective amount of adipic acid dihydrazide (ADH) or wax. The currently disclosed PSA contains no effective amount of poly-hydroxy functional amines. The currently disclosed PSA contains no effective amount of photo cross-linkable monomers. The currently disclosed PSA also contains no effective amount of vinyl acetate or vinyl acetate derivatives.

Currently disclosed, is a label comprising a substrate layer and a pressure sensitive adhesive layer wherein a hydrophilic or hydrophobic acrylic binder is optionally applied on the adhesive side of the substrate layer, and the pressure sensitive adhesive layer comprises at least one hydrophilic monomer, at least one hydrophobic monomer, at least one neutralizer, and at least one surfactant. Optionally, treated with an acrylic binder with Tg greater than 5° C. The hydrophilic acrylic binder can be applied to the substrate at a rate of 0.05-3.0 gsm. The hydrophilic acrylic binder can be applied to the substrate at a rate of 0.05-3.0-gsm.

The PSA adhesive and any attached label can be removed by flaking the PSA coated substrate and submerging the flakes in a sodium hydroxide solution which is at a pH of 12-14 and maintained at a temperature of less than 80° C. and that is constantly agitated. The agitation speed can be at least 100 rpm. After the label separates from the PET, the floating label fraction and the sinking PET fraction can be separated by filtration.

### Examples

The emulsion mixture is generally prepared as follows: A four liter, five neck reactor equipped with a condenser, a mechanical stirrer, a temperature-controlled thermocouple and inlets for initiators and monomers, is fed with 418 g of deionized (“DI”) water and heated to 90-92° C. under a gentle nitrogen flow. In a separate container, a monomer emulsion is prepared by mixing 242 g of DI water, 36.63 g of Aerosol A-102, 26.4 g of Siponate DS-4, 3.3 g of sodium hydroxide, and 1,938.14 g of a monomer mixture composed of 71 wt % of 2-ethylhexyl acrylate (“2-EHA”), 26 wt % of ethyl acrylate (“EA”), and 3 wt % of acrylic acid (“AA”). Next, a solution of a mixture of 1.88 g of sodium carbonate and 10.78 g of sodium persulfate (“NaPS” as initiator) in 33 g DI water is added to the reactor followed by 15.4 g of a 250 nm sized hydrophobic polymeric seed and a 80 to 100 nm sized hydrophilic polymeric seed with a total of 46.2 g of rinse water. Immediately after the two polymeric seed additions, the monomer emulsion is fed into the reactor. The feeding proceeds for 150 minutes along with a co-feed solution of 7.92 g of sodium persulfate in 96.8 g of water while holding the reaction temperature at 85 to 87 C. Once 60% of the Monomer Emulsion is fed into the reactor, 26.84 g of a 40 to 60 nm hydrophilic seed is charged to the reactor followed by an 11 g water rinse. Upon completion of the monomer emulsion addition, the reaction mixture is held for 15 minutes allowing the temperature to drift in the 80 to 86 Deg C. range. After the hold a solution of 0.019 g of FeSO₄-7H₂O and 0.075 g of 42% copper nitrate is added to the reactor as a redox chase promoter. Still holding the temperature at 80 to 86 deg. C., a gradual addition of two chase solutions, one a solution composed of 7.7 g tert-butyl hydroperoxide (70%) (“t-BHP”), 3.52 g of Disponil Fes in 40.37 g DI water and the other a solution of 2.2 g of D(−)-Isoascorbic Acid (IAA) in 90.2 g DI water, are fed into the reactor via two separate feeds over a total of 45 minutes. Fifteen minutes into these feeds, a cooling ramp is started to cool the reaction down to 55 Deg. C. over 60 minutes. Fifteen minutes after the chase feeds end a solution of 0.44 g Potassium Iodate in 12.1 g of water is added to the reactor as a biocide stabilizer. Once the reaction temperature reaches or goes below 55 Deg. C., the pH of the reaction is adjusted to 4 to 4.5 with an addition of 12.32 g of ammonia (28%) neutralizer over 10 minutes. A mixture of 9.9 g of Surfynol 440, 41.38 g of Disponil Fes-77 and 15.95 g of Aerosol OT-75 in 86.46 g of water is then added as a post add formulation to the batch over 30 min. On cooling the reaction to room temperature, 192.17 g of 10% NaOH solution is added to neutralize the batch to a pH of 7.5 to 8.5 over 30 minutes. At a temperature of <45 Deg. C., a biocide package is added. The obtained acrylic dispersion is then filtered through a 100 mesh filter. The obtained acrylic dispersion includes an acrylic-based polymer composed of 71 wt % 2-EHA 26 wt % EA and 3 wt % AA and has a glass transition temperature of −40 C with solids between 57-59%. Weight percent is based on the total dry weight of the acrylic-based polymer.

### Sample Conditioning and Label Lamination

The prepared, fully formulated, wet samples are conditioned for at least 24 hours before testing to ensure that no air bubbles are left and the product has time to equilibrate. After 24 hours, the wet adhesive sample is applied by pipet onto siliconized paper or film and coated at 18 g/m² dry adhesive coat weight using the knife coating technique as shown in table 1. The coated adhesive sample is dried in a convection oven for two minutes at 105° C. and is then conditioned for approximately four hours at 50%+/−5% humidity and 21° C.+/−2° C. After this conditioning period, the adhesive on the siliconized paper or film is laminated onto (ideally pretreated) biaxial oriented polypropylene substrate (BOPP) using a hot roll laminator at 40° C. and a pressure of 40 atm. A 12 kg weight was then placed on the fully assembled laminates for at least four days. For samples treated with an acrylic binder with Tg greater than 5° C., the coating is applied at 2 g/m² and the BOPP substrate is then dried for two minutes at 70° C.

### PSA Properties Testing Procedure

The peel adhesion of the PSA is tested using the Féderation Internationale des fabricants et transformateurs d′ Adhésifs et Thermocollants (“FINAT™”) Test Method No 2. The backing material is removed from a 25 mm wide and at least 175 mm long in the machine direction strip and the adhesive coated facing material is fixed to the test plate. The test plate is secured into the horizontal support which is secured to the bottom jaw of the tester. The machine is set at a 300 mm per minute jaw separation rate and the machine load averaging function is set to average data.

The resistance to shear from a standard glass surface test is carried out using the FINAT™ Test Method No. 8. A 25×25 mm sample strip is attached to a glass plate at a vertical inclination of 2°. The time it takes a 1 kg weight to internally fragment the adhesive film of the strip is measured.

### Wash Off Testing Procedure

The washability of labels is tested using the European PET Bottle Platform (EPBP™) Quick Test (QT) 508 procedure. This procedure is a small-scale mimic of the current industrial procedure used by plastic recycling companies. Samples are submerged in either 80° C. or 65° C. 1% NaOH solution stirred by a magnetic stirrer to 350 rpm. Plastic flakes are washed for less than 15 minutes. Optionally a 0.5% solution of a nonionic surfactant, secondary alcohol ethoxylate is added to better disperse the adhesive particles in the liquid and enable better plastic flakes filtration.

All inventive samples in table 1 below contained 0.5-2.0% sodium salt of a fatty alcohol ether sulfate, >2% of an acetylenic diol ethylene oxide/propylene oxide adduct and >2% dioctyl sodium sulfocuccinate. All samples were neutralized to around a latex pH of 7.6, had around 61.1% solids, a level 2@12 viscosity of 2420 cP and a level 3@30 viscosity of 1764 cP. As shown in the tables below.

TABLE 1
Composition of Comparative and Inventive examples

| | Dry | | | | | | Non-ionic |
|---|---|---|---|---|---|---|---|
| | Adhesive | | | Sodium salt | Acetylenic diol | | surfactant/ |
| | coating | | | of a fatty | ethylene oxide/ | Dioctyl | secondary |
| | weight | | Acrylic | alcohol | propylene | sodium | alcohol |
| | (gsm) | Neutralizer | Binder | ether sulfate | oxide adduct | sulfosuccinate | ethoxylate |
| CE 1 | 18 | Ammonia | none | 0 | 0.3 | 0.5 | 0 |
| IE 1 | 18 | NaOH | Acrylic | 1.3 | 0.3 | 0.5 | 0 |
| | | | Binder | | | | |
| IE 1 | 18 | NaOH | Acrylic | 1.3 | 0.3 | 0.5 | 0 |
| | | | Binder | | | | |
| IE 2 | 18 | NaOH | Acrylic | 1.3 | 0.3 | 0.5 | 0 |
| | | | Binder | | | | |
| IE 2 | 18 | NaOH | Acrylic | 1.3 | 0.3 | 0.5 | 0 |
| | | | Binder | | | | |
| IE 3 | 18 | NaOH | Acrylic | 1.3 | 0.3 | 0.3 | 0.3 |
| | | | Binder | | | | |
| IE 3 | 18 | NaOH | Acrylic | 1.3 | 0.3 | 0.3 | 0.3 |
| | | | Binder | | | | |

TABLE 2
Characterization of comparative and inventive samples

| | | | FTM2: | FTM2: | FTM2: | FTM2: | | |
|---|---|---|---|---|---|---|---|---|
| | | FTM9: | 90° peel | 90° peel | 90° peel | 90° peel | | |
| | | Loop | adhesion - | adhesion - | adhesion - | adhesion - | FTM8: | |
| | | Tack | 20 min | 24 h | 20 min | 24 h | Shear | |
| | Acrylic | Glass | Glass | Glass | HDPE | HDPE | resistance | Wash- |
| | Binder | [N/inch} | [N/inch] | [N/inch] | [N/inch] | [N/inch] | (Glass) | Off % |
| Comparative | none | 5.8 | 4.9 | 6.4 | 4.2 | 4.6 | 48 | 10 |
| IE 1 | Acrylic | 5.8 | 4.7 | 10.2 | 2.9 | 3.2 | 33 | 50-81 |
| | Binder | | | | | | | |
| IE 1 | Acrylic | 7.7 | 4.6 | 20.7 | 3.1 | 3.5 | 18 | 80 |
| | Binder | | | | | | | |
| IE 2 | Acrylic | 7.2 | 4.5 | 11.7 | 2.3 | 2.8 | 33 | 15 |
| | Binder | | | | | | | |
| IE 2 | Acrylic | 8.1 | 5.1 | 9.6 | 3.0 | 3.3 | 20 | 75 |
| | Binder | | | | | | | |
| IE 3 | Acrylic | 7.0 | 4.6 | 9.6 | 2.8 | 2.9 | 39 | 20 |
| | Binder | | | | | | | |
| IE 3 | Acrylic | 6.8 | 4.9 | 10.3 | 2.6 | 2.7 | 21 | 100 |
| | Binder | | | | | | | |

1. A pressure sensitive adhesive layer comprising at least one hydrophilic monomer, at least one hydrophobic monomer, at least one neutralizer, and at least one surfactant.

2. The pressure sensitive adhesive layer of claim 1 wherein the at least one hydrophilic monomer is at least 20% of the composition, and the at least one hydrophobic monomer is at least 50% of the composition.

3. The pressure sensitive adhesive layer of claim 1 wherein the at least one hydrophilic monomer is one or more of the group consisting of ethyl(meth)acrylate and (meth)acrylic acid.

4. The pressure sensitive adhesive layer of claim 1 wherein the at least one hydrophobic monomer is alkyl acrylate.

5. The pressure sensitive adhesive layer of claim 1 wherein the at least one neutralizer is NaOH.

6. The pressure sensitive adhesive layer of claim 1 wherein the at least one surfactant is a sodium salt of a fatty alcohol ether sulfate.

7. The pressure sensitive adhesive layer of claim 1 wherein the at least one surfactant is at least 0.5% of the composition.

8. The pressure sensitive adhesive layer of claim 1 further comprising no effective amount of vinyl acetate or vinyl acetate derivatives.

9. The pressure sensitive adhesive layer of claim 1 further comprising no effective amount of tackifiers.

10. A label comprising a substrate and a pressure sensitive adhesive layer wherein the pressure sensitive adhesive comprises at least one hydrophilic monomer, at least one hydrophobic monomer, at least one neutralizer, and at least one surfactant.

11. The label of claim 10 wherein an acrylic binder with Tg greater than 5° C. is applied to the substrate.

12. A process comprising:
providing an article composed of
(i) a material selected from the group consisting of glass, polyamide, polystyrene, PET, LDPE, LLDPE, PP and HDPEA, and
(ii) a label adhered to a surface of the article, the label comprising a substrate layer and a pressure sensitive adhesive layer; the pressure sensitive adhesive layer comprising at least one hydrophilic monomer, at least one hydrophobic monomer, at least one neutralizer, and at least one surfactant; optionally, treated with an acrylic binder with Tg greater than 15° C.;
submerging the article in a 1% sodium hydroxide solution that is at a temperature from 65° C. to 80° C.; and
washing the article in the 1% sodium hydroxide solution to remove the label with constant agitation at a temperature of less than 85° C. and at a pH between 7 and 14.
